(19) United States
(12) Patent Application Publication
(10) Pub. No.: US 2005/0046636 A1
(43) Pub. Date: Mar. 3, 2005

(54) System and method for on screen displays editing and display

(76) Inventors: Min-Jye Chen, Miaoli City (TW); Chang-Fa Hsieh, Banchiau City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/889,371

(22) Filed: Jul. 12, 2004

(30) Foreign Application Priority Data
Jul. 15, 2003 (TW) 92119217

(51) Int. Cl. G06F 13/00

(52) U.S. Cl. 345/536

(57) ABSTRACT

A system for OSD (On Screen Display) editing and display. The system includes storage media, a display module and a processing unit. The storage media stores a first display of an OSD for the monitor. The display module displays the first display and an editing interface. The first display is edited using the display module and the editing interface to generate an edited first display. The processing unit, connected to the storage media and the display module, updates the edited first display to the storage media, and display it when the OSD is launched.

### BACKGROUND OF THE INVENTION

1. Field of the Invention

The present invention relates to a system and method for OSD (On Screen Display) editing and display, and particularly to a system and method that updates OSDs stored in the monitor and displays them via an OSD module or a computer system.

2. Description of the Related Art

With the wide use of computer systems, specific functions are continuously developed for related applications, increasing the convenience of configuration and operation. For example, monitors provide an OSD with a menu from which to set related settings, such as brightness, contrast, color, position of displayed image, OSD position, and others. Since the OSD module performs the setting, the response time for the setting can be shortened, and the resources of the computer system can be economized.

Since monitor functions differ with brand and type, there is no mechanism for editing the OSD and related settings, functions in different monitors can be difficult or impossible to configure and personalize.

### SUMMARY OF THE INVENTION

It is therefore an object of the present invention to provide a system and method of updating OSDs stored in the monitor and display thereof via an OSD module or computer system.

To achieve the above object, the present invention provides a system including a storage media, a display module, and a processing unit. The storage media stores a first display interface (A1) of an OSD for the monitor. The display module displays the first display interface (A1) and an editing interface. The first display interface (A1) is edited using the display module and the editing interface so as to generate an edited first display interface (A2). The processing unit, connected to the storage media and the display module, updates the edited first display (A2) to the storage media.

A method for OSD editing and display is provided. First, providing a storage media to store a first display interface (A1), a display module displaying the first display interface (A1), and an editing interface are provided in the monitor. The first display interface (A1) is edited using the display module and the editing interface to generate an edited first display interface (A2). Thereafter, a processing unit updates the edited first display (A2) to the storage media.

The storage media further stores a second display interface (B1) of the OSD. The second display interface (B1) is edited by using the display module and the editing interface so as to generate an edited second display interface (B2). Then, the processing unit updates the edited second display interface (B2) to the storage media.

Further, a computer interface is provided with which to edit a third display interface (C1) of the OSD, thereby generating an edited third display interface (C2). Then, the processing unit updates the edited third display interface (C2) to the storage media.

The storage media further records a flag for each display interface, and the processing unit displays the display interface corresponded to the flag.

### BRIEF DESCRIPTION OF THE DRAWINGS

The aforementioned objects, features and advantages of the invention will become apparent by referring to the following detailed description of the preferred embodiment with reference to the accompanying drawings, wherein:

FIG. 1 is a schematic diagram illustrating architecture of the system for OSD editing and display according to the present invention;

FIG. 2 is a flowchart showing the OSD update process using the display module according to the present invention;

FIG. 3 is a flowchart showing the OSD update process using the computer interface according to the present invention; and

FIG. 4 is a flowchart showing the OSD display process according to the present invention.

### DETAILED DESCRIPTION OF THE INVENTION

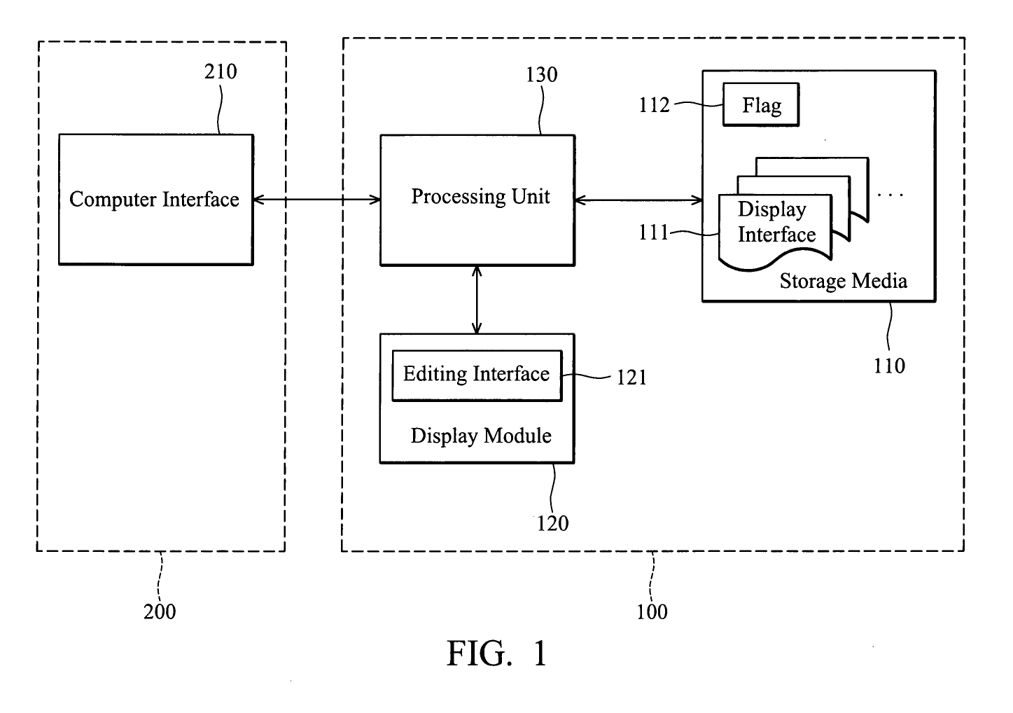

FIG. 1 illustrates architecture of the system for OSD editing and display according to the present invention.

The system includes a monitor 100 and a computer host 200. The monitor 100 includes a storage media 110, a display module 120, and a processing unit 130.

The storage media 110 may be read-only memory, such as EEPROM (Electrically Erasable Programmable Read-Only Memory), and may store a plurality of display interfaces 111 of the OSD of the monitor 100, and a flag 112 corresponded to each display interface. The display module 120 may be an OSD module including related software, firmware and circuits for OSD functions provided by the monitor 100. It should be noted that the display module 120 has an editing interface 121 enabling personalization of the OSD, and editing and update of the stored display interfaces 111. The processing unit 130 may be a microprocessor having operational capability for functions provided by the monitor 100.

In addition, the computer host 200 includes a computer interface 210 allowing different interfaces of the OSD to be downloaded or directly edited, and transmission thereof to the processing unit 130 and the storage media 110. The operations among the storage media 110, display module 120, processing unit 130, and the computer interface 210 are discussed as follows.

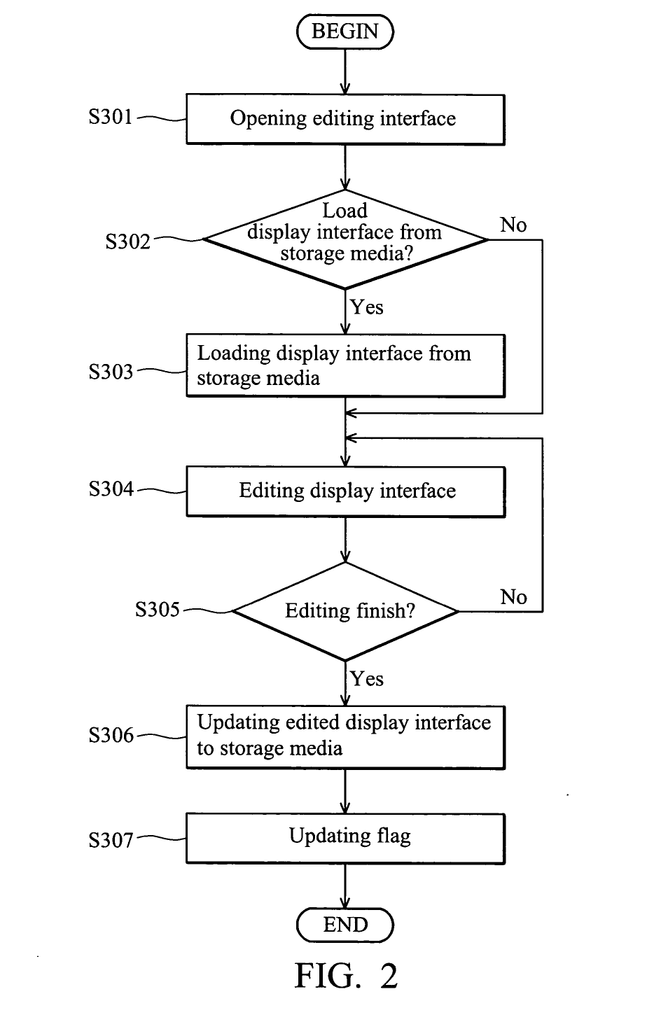

FIG. 2 shows the OSD update process using the display module 120 according to the present invention.

First, in step S301, the editing interface 121 is turned on via the display module 120. Then, in step S302, a display interface (e.g. a first display interface A1) is optionally loaded from the storage media 110.

To create a new display interface (“No” in step S302), the flow goes to step S304. To modify the existing display interface (“Yes” in step S302), the flow goes to step S303. In the step 303, the display module 120 loads the display interface (e.g. the first display interface A1) from the storage media 110 via the processing unit 130. It should be noted that if the storage media 110 has several display interfaces (e.g. the first display interface A1 and a second display interface B1), the display module 120 acquires related information for each display interface via the processing unit 130 from the storage media 110, and provide a user interface including this information. Further, the selected display interface (e.g. the first display interface A1) is loaded to the display module 120.

In step S304, the display interface is edited by using the editing interface 121. Note that this editing can also include selections of OSD functions and corresponding position. After editing (“Yes” in step S305), in step S306, the display module 120 updates the edited display interface (e.g. a first edited display interface A2 or a second edit display interface B2) to the storage media 110 via the processing unit 130. Then, in step S307, the processing unit 130 updates a flag 112 for the edited display interface (the first edited display interface A2 or a second edit display interface B2).

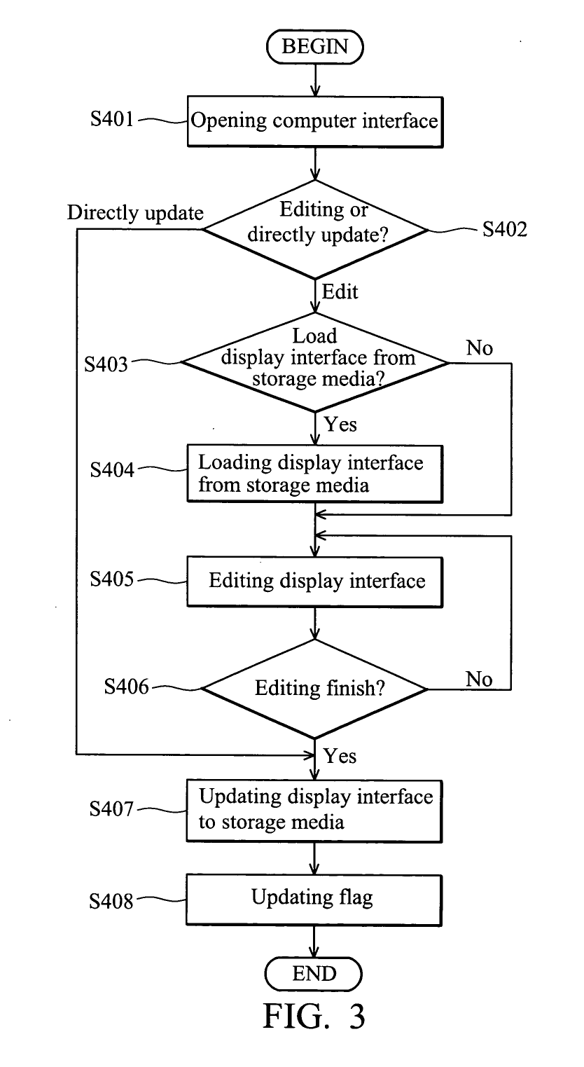

FIG. 3 shows the OSD update process using the computer interface 210 according to the present invention.

First, in step S401, computer interface 210 is turned on, and in step S402, a choice is provided of whether to edit a display interface by using the computer interface 210 or update a display interface to the storage media 110. Since the display interface of the OSD may have been downloaded in advance, the flow goes to step S407 to directly update the display interface to the storage media 110. To edit a display interface by using the computer interface 210, in step S403, a display interface is loaded optionally from the storage media 110. In step S403, a choice is provided of modifying the existing display interface or creating a new display interface.

To create a new display interface (“No” in step S403), the flow goes to step S405. To modify the existing display interface (“Yes” in step S403) , in step S404, the computer interface 210 loads the display interface (e.g. a third display interface C1) from the storage media 110 via the processing unit 130. Similarly, if the storage media 110 stores several display interfaces, the computer interface 210 may acquire related information for each display interface via the processing unit 130 from the storage media 110, and provide one corresponding display interface to be selected. After selection, the display interface (the third display interface C1) is loaded to the computer interface 210.

Then, in step S405, the display interface (the third display interface C1) is edited by using the computer interface 210. After editing (“Yes” in step S406), in step S407, the computer interface 210 updates the edited display interface (the third edited display interface C2) to the storage media 110 via the processing unit 130. Then, in step S408, the processing unit 130 updates the flag 112 for the edited display interface.

It should be noted that steps S307 in FIG. 2 and S408 in FIG. 3 set the newest display interface as the default display. If the latest display is not to be displayed when the OSD launches, steps S307 and S408 can be omitted.

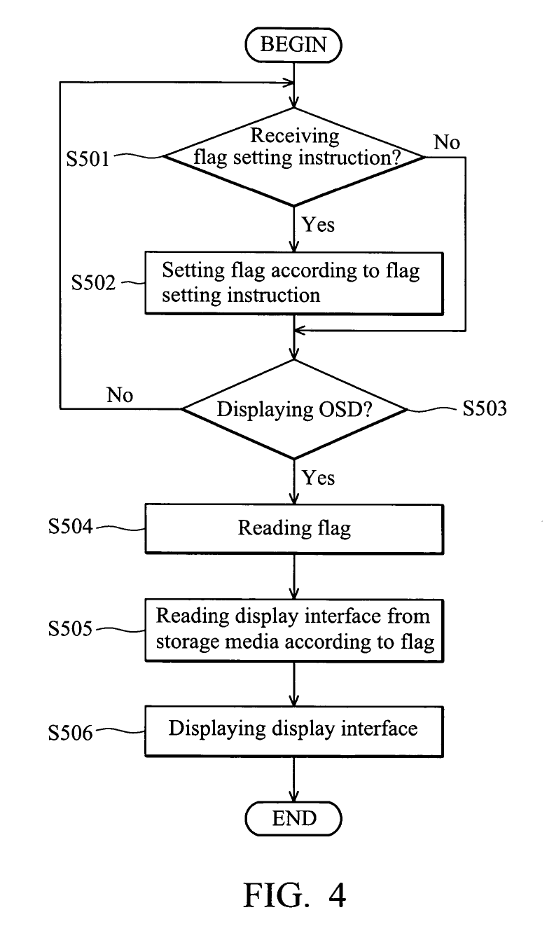

FIG. 4 shows the OSD display process according to the present invention.

First, in step S501, the processing unit 130 determines whether a flag setting instruction has been received. It should be noted that the display module 120 provides an interface from which to select a desired display interface. When one of the display interfaces is selected via the display module, the display module transmits the flag setting instruction for the selected display interface to the processing unit 130. If the processing unit does not receive the flag setting instruction (“No” in step S501), the flow goes to step S503. When the processing unit 130 receives the flag setting instruction (“Yes” in step S501), the flow goes to step S502. In step S502, the processing unit 130 sets the flag 112 in the storage media 110 accordingly.

Then, in step S503, the processing unit 130 determines whether it is to display the OSD. If no (“No” in step S503), the flow returns to step S501. If so (“Yes” in step S503), in step S504, the processing unit 130 downloads a flag 112 from the storage media 110. Thereafter, the processing unit 130 loads a display interface according to the flag 112 in step S505, and displays the display interface via the display module 120 in step S505.

As a result, the system and method for OSD editing and display according to the present invention allows OSDs in the monitor to be updated and displayed via the OSD module or the computer system, preventing inconvenience and increasing flexibility when using the OSD.

Although the present invention has been described in its preferred embodiments, it is not intended to limit the invention to the precise embodiments disclosed herein. Those skilled in this technology can still make various alterations and modifications without departing from the scope and spirit of this invention. Therefore, the scope of the present invention shall be defined and protected by the following claims and their equivalents.

1. A system for OSD (On Screen Display) editing and display in a display device, comprising:
a storage media to store a first display interface A1 of the OSD;
a display module to display the first display interface A1 and an editing interface, and the first display interface A1 being edited by using the editing interface so as to generate an edited first display interface A2; and
a processing unit coupled to the storage media and the display module to update the edited first display interface A2 to the storage media.

2. The system as claimed in claim 1 wherein the storage media further stores a flag for the edited first display interface A2.

3. The system as claimed in claim 2 wherein the processing unit further reads the flag in the storage media, and displays the edited first display interface A2 according to the flag, via the display module.

4. The system as claimed in claim 2 wherein the display module further resets the flag in the storage media via the processing unit.

5. The system as claimed in claim 1 wherein the storage media further stores a second display interface B1 of the OSD, edited to generate an edited second display interface B2 using the display module, and the processing unit stores the edited second display interface B2 to the storage media.

6. The system as claimed in claim 5 wherein the processing unit further updates a flag in the storage media for the edited second display B2.

7. The system as claimed in claim 1 further comprising a computer interface storing a third display interface C1, edited to generate an edited third display interface C2 using the computer interface, and the processing unit storing the edited third display interface C2 to the storage media.

8. The system as claimed in claim 7 wherein the processing unit further updates a flag in the storage media for the edited third display C2.

9. The system as claimed in claim 1 wherein the storage media is read-only memory of the display device.

10. The system as claimed in claim 1 wherein the display module is an OSD module of the display device.

11. A method for OSD (On Screen Display) editing and display in a display device, comprising the steps of:
providing a storage media in the display device to store a first display interface A1 of the OSD;
providing a display module to display the first display interface A1 and an editing interface, the first display interface A1 being edited by using the editing interface to generate an edited first display A2; and
providing a processing unit coupled to the storage media and the display module to update the edited first display interface A2 to the storage media.

12. The method as claimed in claim 11 further comprising storing a flag for the edited first display interface A2 in the storage media.

13. The method as claimed in claim 12 further comprising reading of the flag in the storage media, and displaying of the edited first display interface A2 according to the flag via the display module by the processing unit.

14. The method as claimed in claim 12 further comprising resetting of the flag in the storage media via the processing unit by the display module.

15. The method as claimed in claim 11 further comprising storing a second display interface B1 of the OSD in the storage media, editing the second display interface B1 to generate an edited second display interface B2 by using the display module, and the storage media of the edited second display interface B2 to the storage media by the processing unit.

16. The method as claimed in claim 15 further comprising a step of updating a flag in the storage media for the edited second display interface B2 by the processing unit.

17. The method as claimed in claim 11 further comprising providing a computer interface storing a third display interface C1, editing the third display interface C1 to generate an edited third display interface C2 using the computer interface, and storage media of the edited third display to the storage media by the processing unit.

18. The method as claimed in claim 17 further comprising a step of updating a flag in the storage media for the edited third display interface C3 by the processing unit.

19. The method as claimed in claim 11 wherein the storage media is read-only memory of the display device.

20. The method as claimed in claim 11 wherein the display module is an OSD module of the display device.
